(19) United States
(12) Patent Application Publication
(10) Pub. No.: US 2006/0026900 A1
(43) Pub. Date: Feb. 9, 2006

(54) Method for storing and delivering hydrogen to fuel cells

(76) Inventor: Bor Z. Jang, Fargo, ND (US)

Correspondence Address: Bor Z. Jang, 2902 28th Ave. S.W., FARGO, ND, 58103, US

(21) Appl. No.: 10/914,061

(22) Filed: Aug. 9, 2004

(51) Int. Cl. H01M 8/06; F17D 1/04

(52) U.S. Cl. 48/190; 429/17

(57) ABSTRACT

A hydrogen gas storage and supply method including: (a) providing a chamber and, contained therein, a plurality of shell-core micro-spheres, each comprising a shell and a hollow or porous core, filled with pressurized hydrogen gas at an internal pressure P; and (b) heating the micro-spheres to a temperature T to reduce the shell tensile strength σₜ to an extent that a tensile stress σ experienced by a shell of the micro-spheres meets the condition of σ≧ασₜ, causing hydrogen to diffuse out of the micro-spheres to provide hydrogen fuel from the chamber to a hydrogen-consuming device, where the material-specific parameter α has a value between 0.3 and 0.7. The shell stress scales with the internal hydrogen gas pressure and the tensile strength σₜ decreases with increasing micro-sphere temperature. For instance, this condition is met when the micro-spheres are heated to a temperature within the range of [Tg−25° C.] to [Tg+25° C.] for an amorphous polymer (Tg=glass transition temperature or softening point) or withing the range of [Tm−25° C.] to [Tm+10° C.] for a crystalline polymer (Tm=melting point). This method is useful for feeding hydrogen to a fuel cell used in a portable microelectronic device, automobile, and unmanned aerial vehicle where light weight is an important factor.

### FIELD OF THE INVENTION

This invention relates to a hydrogen storage and supply method and more particularly to a method for safely storing and feeding hydrogen to a power-generating device such as a fuel cell or a hydrogen combustion engine.

### BACKGROUND OF THE INVENTION

A major drawback in the utilization of hydrogen-based fuel cells for powering vehicles or microelectronic devices is the lack of an acceptable lightweight and safe hydrogen storage medium. Four conventional approaches to hydrogen storage are currently in use: (a) liquid hydrogen, (b) compressed gas, (c) cryo-adsorption, and (d) metal hydride storage systems. A brief description of these existing approaches is given below:
(a) The liquid hydrogen storage approach offers good solutions in terms of technology maturity and economy, for both mobile storage and large-volume storage systems with volumes ranging from 100 liters to 5000 m³. However, the containers for storing the liquefied hydrogen are made of very expensive super-insulating materials.
(b) The compressed gas storage approach is usually applied in underground supply systems, similar to a network of natural gas pipelines. This is an economical and simple approach, but it is unsafe and not portable. Compressed hydrogen gas in a large steel tank could be an explosion hazard.
(c) The cryo-adsorbing storage approach involves moderate weight and volume. In this approach, hydrogen molecules are bound to the sorbent only by physical adsorption forces, and remain in the gaseous state. The adsorbing temperature is in the range of 60 to 100° K. Activated carbon is commonly used as the sorbent due to its large number of small pores serving as hydrogen storage sites. The efficiency of H₂ uptake is no more than 7 wt %, which is equivalent to about 20 kg H₂ per cubic meter of activated carbon. The disadvantages of this approach are related to the low capacity and the cryogenic temperature required, which makes it necessary to use expensive super-insulated containers. The following two papers are directly related to this subject: (1) R. Chahine and T. K. Bose, “Low-pressure adsorption storage of hydrogen,” International J. of Hydrogen Energy, 19-2 (1994) 161-164; (2) H. Hynek, et al., “Hydrogen storage by carbon sorption,” International J. of Hydrogen Energy, 22-6 (1997) 601-610.
(d) The metal hydrides can store large quantities of H₂ via a chemical reaction of H+M ⇄M-H, wherein M is a selected metal element. Two major metal systems, i.e. Fe—Ti and Mg—Ni, have been applied as hydrogen storage media and have been put into use in automobiles driven by a H₂/O₂ fuel cell. The operating temperature is 40-70° C. for the Ti—Fe system and 250-350° C. for the Mg-Ni system. The hydrogen storage capacity is less than 5 wt % for Ni—Mg and 2 wt % for Fe—Ti, which corresponds to less than 70 kg H₂ per m³ of metals. Furthermore, metal hydride systems normally require 20-40 bar pressure to keep the hydrogen in equilibrium. This renders the container for the metal hydride too heavy and expensive, and limits the practical exploitation of these systems for portable electronic and mobility applications.

More recently, researchers have expressed great interest in storing H₂ in nanostructured carbon materials. For instance, Dillon, et al. (“Storage of hydrogen in single-walled carbon nanotubes,” Nature, 386 (1997) 377-379) reported that about 0.01 wt % of H₂ was absorbed by raw carbon nanotube material (which was estimated to contain approximately 5 wt % of the single wall nanotube, SWNT) at 130° K. Chambers, et al. (“Hydrogen storage in graphite nanofibers,” J. Phys. Chem., 102 (22) (1998) 4253-4256) and Rodriguez and Baker (U.S. Pat. No. 5,653,951 (Aug. 5, 1997) and No. 6,159,538 (Dec. 12, 2000)) claimed that tubular, platelet, and herringbone-like carbon nano-fibers (CNF) were capable of adsorbing in excess of 11, 45, and 67 weight % of H₂, respectively, at room temperature and at a pressure of 12 MPa. However, there has been no independent confirmation of these unusually high figures.

The above review indicates that the hydrogen storage technology still has four major barriers to overcome: (1) low H₂ storage capacity, (2) difficulty in storing and releasing H₂ (normally requiring a high T to release and a high P to store), (3) high costs, and (4) potential explosion danger. A need exists for a new high-capacity medium that can safely store and release hydrogen at near ambient temperature conditions. If high pressures are involved in storing hydrogen, the conditions must still be safe.

Teitel (“Hydrogen supply method,” U.S. Pat. No. 4,211,537 (Jul. 8, 1980); “Hydrogen supply system,” U.S. Pat. No. 4,302,217 (Nov. 24, 1981)) proposed an interesting system for supplying hydrogen to an apparatus (e.g., a combustion engine). This system contains a metal hydride-based hydrogen supply component and a micro cavity-based hydrogen storage-supply component which in tandem supply hydrogen for the apparatus. The metal hydride-based component includes a first storage tank filled with a metal hydride material which, when heated, decomposes to become a metal and hydrogen gas. When cooled, the metal will absorb hydrogen to refuel the component (via the re-formation of metal hydride). This first storage tank is equipped with a heat exchanger for both adding heat to and extracting heat from the material to regulate the absorption/desorption of hydrogen from the material. The micro cavity-based component includes a second tank containing individual glass micro cavities that contain or “encapsulate” hydrogen molecules held therein under a high pressure. The hydrogen is released from the micro cavities by heating the cavities. This heating is accomplished by including a heating element within the micro cavity-containing tank. The metal hydride-based component supplies hydrogen for short term hydrogen utilization needs such as peak loading or acceleration. The micro cavity component supplies an overall constant demand for hydrogen and is also used to regenerate or refuel the metal hydride component.

The micro cavity storage component consists of a large plurality of micro cavities filled with hydrogen gas at pressures possibly up to 10,000 psi (689.5 MPa or 680.3 atm). The micro cavities generally are micro-spheres with a diameter from about 5 to about 500 microns. The walls of the micro cavities are generally from about 0.01 to about 0.1 that of the diameter of the micro cavities. The filled micro-spheres may be moved from operation to operation like a fine sand or suspended in a gas or fluid for transportation. Hollow micro-spheres can be made of plastic, carbon, metal, glasses or ceramics depending upon the performance characteristics desired. Teitel suggested the preferred micro-spheres to be made of silicate glasses. Under refueling conditions (e.g., under high hydrogen pressures and elevated temperatures) hydrogen will diffuse into the micro cavities. When stored at normal temperatures and under atmospheric pressure the hydrogen remains inside the micro cavity under high pressure. Upon reheating the micro cavity, the hydrogen is caused to diffuse outside the cavity and is available for utilization by the apparatus.

Advantages of the Teitel-type System: The present inventor envisions that hollow micro spheres provide a much safer method for storing and transporting hydrogen. Each micro-sphere acts as its own pressure vessel. At 50 μm or smaller in diameter and with a wall of 1 μm or less in thickness, each micro-sphere may seem to contain only a small amount of hydrogen. However, a large number of micro-spheres can be bunched together in a tank which can be made of light weight materials such as plastics due to the fact that the tank does not have to be under a high pressure. This would make for a sizeable storage system that weighs much less than a traditional heavy steel tank. In an accident, the micro-sphere system would not break to release a large quantity of hydrogen, as would the rupture of a big steel tank of gas. Instead, some of the micro-spheres would just spill onto the ground. A limited number of micro-spheres could possibly break, but releasing only minute amounts of hydrogen.

It is further envisioned that, when fully implemented for automotive applications, the system could provide a level of convenience comparable to the situation of today's drivers filling up their cars with gasoline at a convenient gas station. The refueling of micro-spheres in a car could be accomplished in two steps. First, a vacuum would suck the used micro-spheres out and send them to a tank for refilling of hydrogen. New, hydrogen-filled micro-spheres could then be pumped in from a different tank. The consumer would not see much difference from today's system. The micro-spheres are very light, inexpensive and can be repeatedly filled and refilled without degradation.

Shortcomings of the System Proposed by Teitel: (1) The Teitel system requires two tanks: one primary tank containing heavy metal hydride and a supplementary micro-sphere tank; the latter primarily playing a secondary role of recharging the primary tank. Such a heavy and complex system may not be very suitable for automotive and aerospace applications and is totally unfit for portable device applications (e.g., for use in fuel cells to power computers, cell phones, and other micro-electronic devices). It would be advantageous to utilize a hydrogen supply system based on micro-spheres alone. (2) In the Teitel system, heating of the glass micro-spheres for releasing the hydrogen requires blowing the micro-spheres with hot gases or powering an electrical heating element to heat up the micro-spheres. In either case, a significant amount of energy is consumed if glass micro-spheres, as suggested by Teitel, are used. Tracy, et al. (U.S. Pat. No. 4,328,768 (May 11, 1982)) proposed a hydrogen storage and delivery system based on a similar approach of using hollow micro-spheres. Both Tracy, et al. and Teitel did not suggest any convenient, easy-to-control, and less energy-intensive way to heat up the micro-spheres.

Hence, an object of the present invention is to provide a method that features a high hydrogen storage capacity and an ability to safely and reliably store and feed hydrogen fuel to a power-generating device such as a combustion engine or fuel cell.

Another object of the present invention is to provide a method that is capable of storing hydrogen in micro-spheres and releasing the hydrogen fuel in a controlled manner without involving an excessively high micro-sphere heating temperature.

Still another object of the present invention is to provide a hydrogen storage and supply material that is particularly suitable for feeding hydrogen fuel to fuel cells for use in apparatus such as portable electronic devices, automobiles and unmanned aerial vehicles (UAV) where device weight is a major concern.

### SUMMARY OF THE INVENTION

The present invention provides a hydrogen gas storage and supply method, which includes two essential steps: (a) providing a chamber and a plurality of shell-core micro-spheres, each comprising a shell and a hollow or porous core, filled with pressurized hydrogen gas at an internal pressure P with the chamber containing therein the micro-spheres and free spaces not occupied by the micro-spheres; and (b) heating the micro-spheres to a temperature T to reduce the shell tensile strength σₜ to an extent that a tensile stress σ experienced by a shell of the micro-spheres spheres meets the condition of a σ≧ασₜ, causing hydrogen to diffuse out of the micro-spheres to provide hydrogen fuel from the chamber to a hydrogen-consuming device, where the material-specific parameter α has a value between 0.3 and 0.7. The shell stress a scales with the internal hydrogen gas pressure P and the tensile strength σₜ is a strong function of the micro-sphere temperature; σₜ decreasing with increasing temperature. This implies that for a highly pressurized micro-sphere (hence, a high tensile stress σ), it will take a lower temperature to effectively release the hydrogen gas.

The above condition was met, in the cases of using polymer micro-spheres to store hydrogen, when the temperature T was raised to be within the range of [Tg−25° C.] to [Tg+25° C.] for an amorphous or glassy polymer (Tg=glass transition temperature or softening point) or withing the range of [Tm−25° C.] to [Tm+10° C.] for a crystalline polymer (Tm=melting point). For glass micro-spheres, the condition was typically met when the temperature T was within the range of [Tg−50° C.] to [Tg+50° C.] for a glass with a glass transition temperature or softening point, Tg. For most of the organic polymers, the Tg or Tm is below 300° C. and more typically below 200° C. For conventional glasses, the Tg is typically higher than 500° C.; but for several classes of low-Tg glasses, the Tg is lower than 400° C. (some <300° C. or even <200° C.). We were able to produce hollow or porous core-shell micro-spheres from these glass materials and found it very advantageous to use these low-Tg micro-spheres to store hydrogen. Although low in Tg, these glasses have a sufficiently high tensile strength that make them capable of storing a great amount of hydrogen gas. Furthermore, the low Tg values mean low energy consumption and ease in reaching the critical temperature to release the hydrogen fuel.

### BRIEF DESCRIPTION OF THE DRAWINGS

FIG. 1 Schematic of shell-core spheres: (a) shell-hollow core sphere and (b) shell-porous core spheres with the shell and pore wall being made of a plastic or glass material.

FIG. 2 Schematic of a core-shell structure with an external radius R and a shell thickness ΔR.

FIG. 3 The hydrogen storage capacities of a hollow glass micro-sphere, expressed in terms of the ratio of the total hydrogen mass stored/the sphere mass or total hydrogen mass stored/the sphere volume as a function of the shell thickness-to-micro-sphere radius ratio, assuming a maximum shell tensile stress of 600 MPa.

FIG. 4 The hydrogen storage capacities of a hollow engineering plastic micro-sphere, expressed in terms of the ratio of the total hydrogen mass stored/the sphere mass or total hydrogen mass stored/the sphere volume as a function of the shell thickness-to-micro-sphere radius ratio, assuming a maximum shell tensile stress of 200 MPa.

FIG. 5 A hydrogen release criterion expressed in terms of a threshold strength that must be exceeded by a pressure-induced tensile stress in the shell. The threshold strength decreases with increasing micro-sphere temperature and the tensile stress experienced by the shell scales with the hydrogen storage pressure.

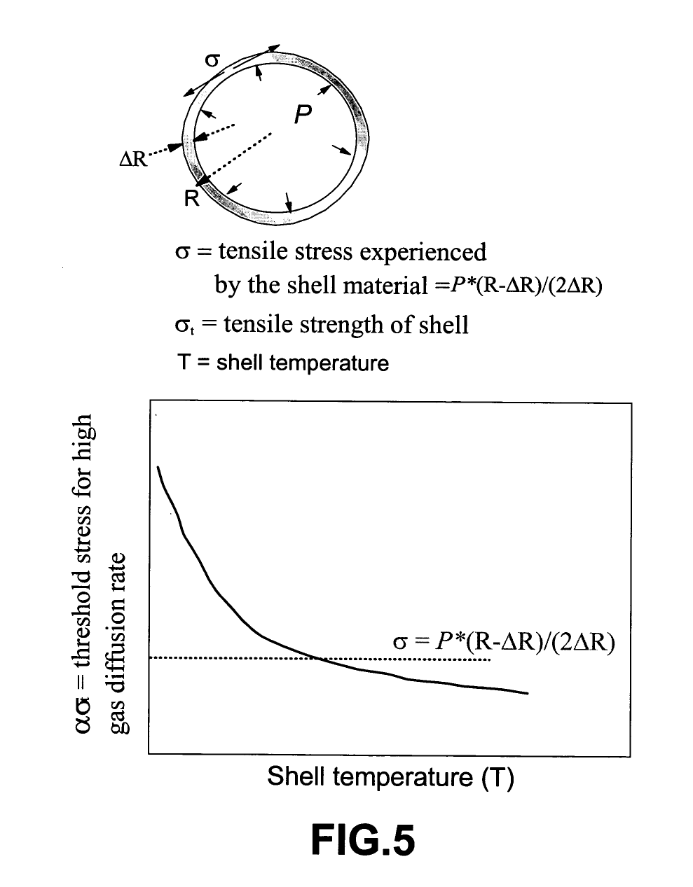

FIG. 6 Schematic of a container containing a multiplicity of shell-core micro-spheres that can be heated to supply hydrogen gas to a fuel cell.

FIG. 7 Hydrogen release rate of polycarbonate shell-porous core micro-spheres as a function of the micro-sphere temperature.

FIG. 8 Hydrogen release rate of low-Tg phosphate glass based shell-hollow core micro-spheres as a function of the micro-sphere temperature.

### DETAILED DESCRIPTION OF PREFERRED EMBODIMENTS

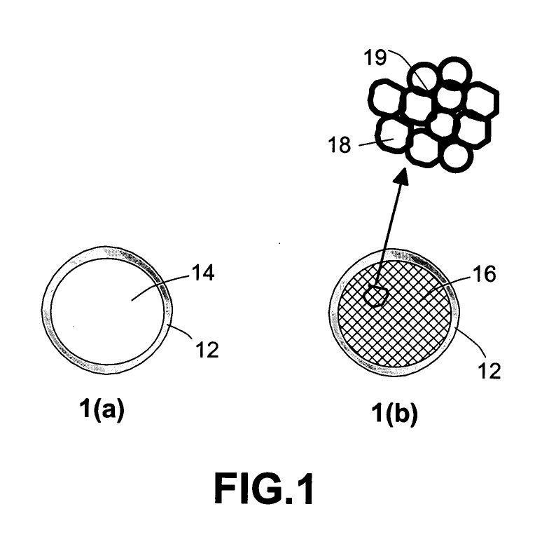

Two shell-core (or core-shell) particles that can be used to store and supply hydrogen fuel to a fuel cell or other hydrogen-consuming apparatus are shown in FIG. 1(a) and FIG. 1(b). These particles are herein referred to as spheres or micro-spheres, although they are not necessarily spherical in shape. The particle shown in FIG. 1(a) is composed of a glass or plastic shell 12 and a hollow core 14. The shell 12 provides the needed strength to contain gas molecules inside the hollow core 14 under a reasonably high gas pressure, P. The micro-sphere shown in FIG. 1(b) is composed of a glass or plastic shell 12 and a micro- or nano-porous core 16. The shell 12 provides the needed mechanical strength to contain gas molecules inside the pores 18 of the porous core 16 under a gas pressure, P. Individual pores, nanometer- or micrometer-scaled, are separated by a pore wall 19. The maximum pressure that these shell-core spheres can withstand is dictated by the shell and pore wall strength. These micro-spheres may be considered as individual “pressure vessels.”

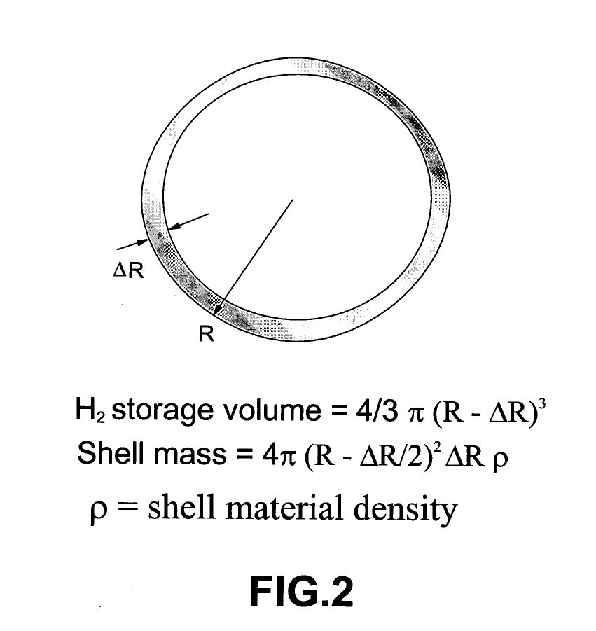

Basic principles and essential technological considerations behind the approach of using hollow or porous core-shell micro-spheres are presented as follows: Consider a hollow micro-sphere (FIG. 2) with a shell thickness ΔR, shell material density ρ, outer radius R, and an internal hydrogen gas pressure P. The total hydrogen gas storage volume is V=(4/3) π (R−ΔR)³ and the total shell mass is approximately mₛ=4π(R−ΔR/2)²αRρ. Assume that the ideal gas law (n=PV/RT; R=universal gas constant) holds in the present case, then the number of moles n of hydrogen molecules that can be stored in a micro-sphere of volume V is proportional to the internal pressure P. (When necessary, a compression ratio may be included in the ideal gas equation to account for the non-ideal gas behavior at ultra-high pressures.) With the molar mass of hydrogen molecule H₂=2 g/mole, the total hydrogen mass stored in a micro-sphere is m_{H}_{²}=2n grams. The ratio m_{H}_{²}/mₛ (the hydrogen mass stored/the micro-sphere material mass) is an index or measure of the hydrogen storage capability of a hollow micro-sphere,
m_{H}_{²}/mₛ=(2PV/RT)/(4π(R−ΔR/2)²ΔRρ)=2P(R−ΔR)³/[3RT(R−ΔR/2)²ΔRρ] (1)
The volumetric hydrogen storage capacity, defined to be (the total hydrogen mass stored in a micro-sphere)/(total volume of a micro-sphere:
m_{H}_{²}/Vₛ=(2P/RT)[(4/3)π(R−ΔR)³]/[(4/3)πR³]=(2P/RT)(1−ΔR/R)³ (2)
Both Eq.(1) and Eq.(2) may be re-written in terms of the highest tensile stress σₘₐₓ that the micro-sphere shell can withstand without leaking or fracturing. The tensile stress experienced by the thin shell is given approximately by σ=P(R−ΔR)/(2ΔR). Hence, the maximum pressure that can be tolerated by a micro-sphere is given by P=σₘₐₓ(2ΔR)/(R−ΔR), which may be substituted back into Eq.(1) and Eq.(2) to obtain:
m_{H}_{²}/mₛ=4σₘₐₓ(R−ΔR)²/[3RT(R−ΔR/2)²ρ]≈4σₘₐₓ/[3RTρ] (if ΔR small) (3)
m_{H}_{²}/Vₛ₌₍4σₘₐₓ/RT)(ΔR/R) (1−ΔR/R)² (4)

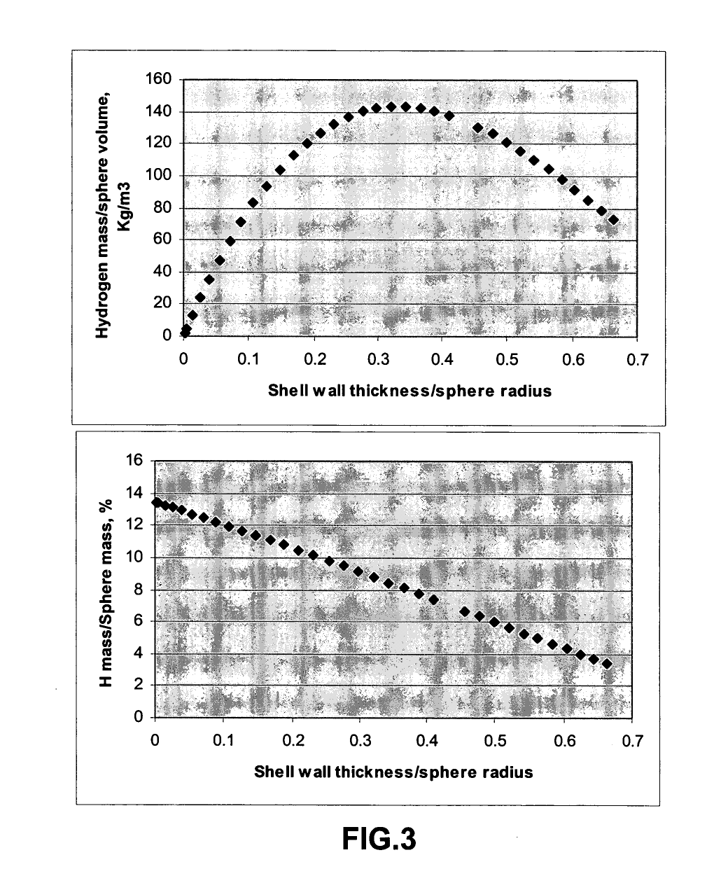

To illustrate the significance of using micro-spheres for storing hydrogen fuel, Eq.(3) and Eq.(4) are used to calculate the typical ratio m_{H}_{²}/mₛ for both glass micro-spheres and plastic micro-spheres. FIG. 3 shows the dependence of m_{H}_{²}/mₛ and m_{H}_{²}/Vₛ on the ratio of shell thickness-to-micro-sphere radius for glass micro-spheres of diameters 5-28 μm with shell thickness of 0.1-3.4 μm, assuming a glass density of 2.4 g/cm³ and a maximum shell tensile stress of 600 MPa. This magnitude of tensile stress is approximately 15-40% of the tensile strengths of inorganic glass materials. The data indicate that glass micro-spheres potentially provide the highest hydrogen storage capacity as compared to all other types of materials listed in Table 1. This is due to their relatively high tensile strengths that can hold correspondingly high internal pressure values. Yet, glass materials have moderately high densities.

TABLE 1
Hydrogen storage capacity of more commonly used media.

| Hydrogen storage | H atom density, | H storage | H content, m_{H2}/mₛ | |
|---|---|---|---|---|
| medium | 10²²/cm³ | relative density | (% mass) | Comments |
| H₂ gas (STP) | 5.4 × 10⁻³ | — | 100 | No container |
| Steel cylinder | 8.1 × 10⁻¹ | 150 | 100 | <1% if steel cylinder mass is considered |
| Liquid H₂ | 4.2 | 778 | 100 | Weight of container not included; |
| at −263° C. | | | | Power needed to maintain at low T |
| LaNi₅H₆ | 6.2 | 1148 | 1.37 | Metal hydride, chemical method |
| FeTiH_{1.95} | 5.7 | 1056 | 1.85 | |
| MgNiH₄ | 5.6 | 1037 | 3.6 | |
| MgH₂ | 6.6 | 1222 | 7.65 | |
| Activated C (77° K) | — | — | 5.3 | |
| Carbon nanotube | — | — | 3-9 | |
| (CNT) | | | | |
| Organic liquids | — | — | 7.19 | e.g., benzene |
| KHNO₃ or NaHCO₃ | — | — | 2 | |
| Glass micro- | — | — | 3-40 (P = 100 MPa; | Typically diameter = 10-200 μm, |
| spheres | | | 2R = 10-100 μm) | shell = 1-20 μm, 10-2,000 MPa. |
| Plastic micro- | — | — | 2-30 (P = 25 MPa; | Typically diameter = 1-200 μm, |
| sphere | | | 2R = 10-100 μm) | shell = 0.05-20 μm, 5-200 MPa. |

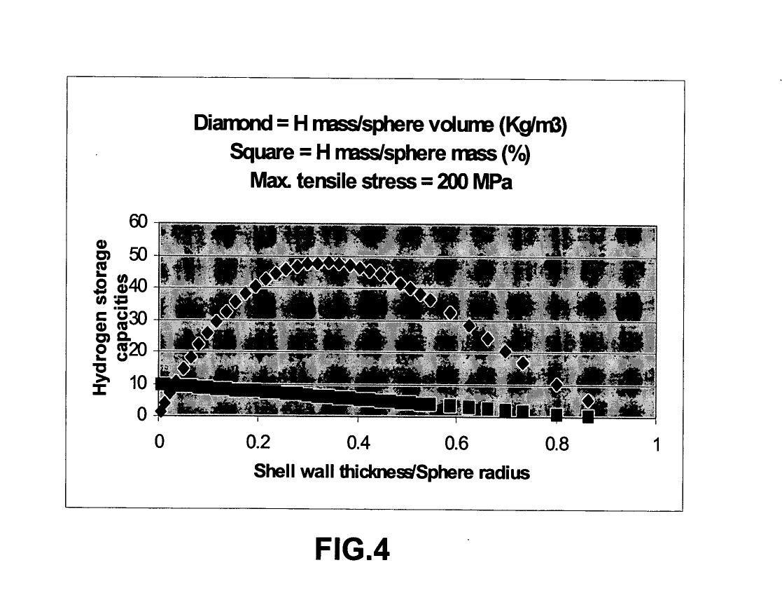

The m_{H}_{²}/mₛ and m_{H}_{²}/Vₛ values for typical plastic micro-spheres (σₘₐₓ=200 M Pa, ρ=1.1 g/cm³), shown in FIG. 4 and Table 1, also indicate that plastic micro-spheres have very high hydrogen storage capacities, only next to glass micro-spheres. These data clearly demonstrate the advantages of using glass and plastic micro-spheres to store hydrogen fuel.

Although Teitel (U.S. Pat. No. 4,211,537 and No. 4,302,217) and Tracy, et al. (U.S. Pat. No. 4,328,768) proposed the use of micro-spheres for storing and feeding hydrogen, they both did not recognize the difficulties in using glass and plastic micro-spheres to deliver hydrogen fuel, on demand, to a fuel cell or combustion engine at a controlled rate that is compatible with the operation of these fuel-consuming apparatus. Ceramic and glass materials do show good gas permeation resistance at room temperature, which is a desirable feature to achieve a stable hydrogen storage. However, they do not allow hydrogen gas molecules to readily diffuse out of micro-spheres at a sufficiently high rate at room temperature. This is largely due to the normally low gas permeability of high-strength glass or ceramic materials at room temperature and their high glass transition or softening temperatures. It is commonly believed in the hydrogen storage technology community that heating of gas-pressurized hollow glass spheres to a high temperature close to their glass transition temperatures (Tg, normally higher than 500° C.) is required in order to have a sufficiently high hydrogen release rate. The melting points of crystalline ceramics are even much higher. This would consume great amounts of energy and would take a long time to reach such high temperatures, making it impractical to use these hollow glass spheres to store and supply hydrogen to a fuel cell or combustion engine.

By contrast, polymers have a much lower glass transition temperature (Tg, for an amorphous, non-crystalline polymer) or lower melting points (Tm, for a crystalline polymer), typically from well below room temperature upward to 300° C. Amorphous, glassy plastics typically have a glass transition temperature from slightly above room temperature to below 200° C. (e.g., polystyrene has a Tg≈100° C. and polycarbonate Tg≈150° C.). The hollow spheres or shell-porous core structures made of these materials would be ideal materials for hydrogen release and supply. The only concern is that unreinforced plastics and rubbers exhibit a relatively low strength (tensile strength of engineering plastics, σₜ, ≈60-120 MPa) and, hence, may not be expected to hold a very high amount of hydrogen given the same volume, as compared to silicate glass (compressive or crush strength up to 1,200 MPa). However, the results of our calculations (FIG. 4 and Table 1) have clearly shown that, despite their lower strengths, plastic micro-spheres are still potentially capable of providing an exceptional hydrogen storage capacity on a weight basis. This is possible since their densities are low and they can be readily produced in an ultra-thin shell-core structure. The tensile strength of a polymer can be significantly increased up to 1,000 MPa if a high degree of chain orientation is achieved. They are of much lower cost as compared with metal hydride compounds, carbon nanotubes, carbon nano-fibers, etc. Both FIG. 3 and FIG. 4 indicate that the shell thickness-to-radius ratio should preferably be smaller than 0.2 and further smaller than 0.1.

The above considerations have highlighted the importance of controlling parameters such as the shell thickness (during material processing), micro-sphere size, shell strength, maximum internal pressure, and material temperature in order to achieve a high hydrogen storage capacity and a controlled release rate of hydrogen when a hydrogen-consuming apparatus is in operation. After intensive research and development efforts in these aspects, the following discoveries were made:
(1) For each of the hydrogen gas-filled glass and plastic core-shell micro-spheres studied, there exists a threshold fractional tensile strength level (ασₜ) which, if exceeded by an internal pressure-induced tensile stress (σ), will result in a dramatic increase in hydrogen permeation rate through the shell to reach the space outside the micro-sphere. Here, α is a material-specific constant, typically in the range of 0.3 to 0.7 (but more typically in the range of 0.4 to 0.6), α is the tensile strength of the micro-sphere shell, and the tensile stress experienced by the thin shell is given approximately by σ=P(R−ΔR)/(2ΔR). The critical condition exists when:
   σ=P(R−ΔR)/(2ΔR)≧ασₜ or P≧αₜ(2ΔR)/(R−ΔR) (5)
   It is essential to realize that the tensile strength at of a micro-sphere can be much greater than that of its much larger counterpart since a larger particle tends to have larger cracks or a larger number of defects. The tensile strength of either a plastic or a glass material strongly depends upon the material temperature (T); the higher the T, the lower the σₜ. It is also important to recognize that the tensile stress (σ) experienced by the shell is directly proportional to both the internal pressure and micro-sphere size (inner radius=R−ΔR), and inversely proportional to the shell thickness (ΔR). Although, on one hand, one would want to make the shell as thin as possible to achieve a larger hydrogen storage capacity per material weight basis (as indicated in Eq.(1)-Eq.(4) and FIG. 3 or FIG. 4) but, on the other, too thin a shell would imply a very high shell stress (Eq.5), increasing the risk of a hydrogen gas leak through the shell. According to Eq.(5), the internal pressure must be less than [ασₜ(2ΔR)/(R−ΔR)] in order for the micro-sphere to hold the hydrogen gas inside the micro-sphere without a significant gas leak. Contrarily, in order to release the hydrogen gas at a reasonable rate on demand (e.g., when a fuel cell is in operation), the temperature may be increased to the extent that the reduced magnitude of [ασₜ(2ΔR)/(R−ΔR)] is lower than the internal pressure, P. Thus, Eq.(1)-Eq.(5) provide a guideline for designing an effective way to store and release hydrogen gas.

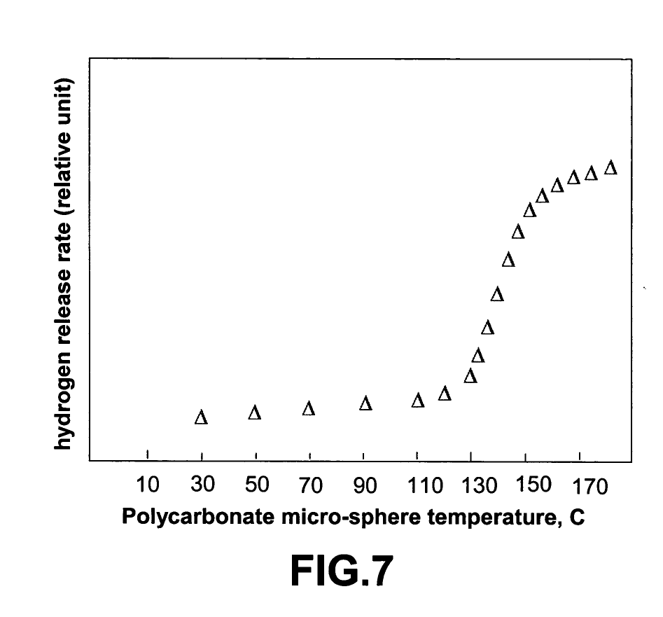

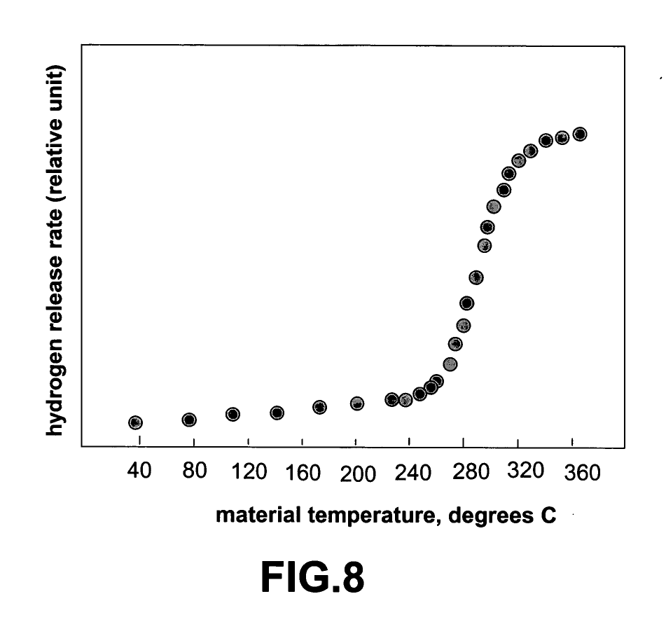

(2) Once the critical condition (Eq.(5)) is exceeded, the micro-spheres begin to release hydrogen at a rate that increases rapidly with the material temperature and reaches a plateau value some 20 degrees above the Tg of a glassy polymer and some 50 degrees above the Tg of a glass, as shown in FIG. 7 and FIG. 8, respectively.

(3) Several groups of low-Tg glass materials (Tg<400° C. and, in some cases, <350° C.) are particularly suitable for storing hydrogen with a high storage capacity and for conveniently releasing hydrogen without the need to involve an excessively high temperature. A temperature T<350° C. (<200° C. in some cases) is found to be adequate.

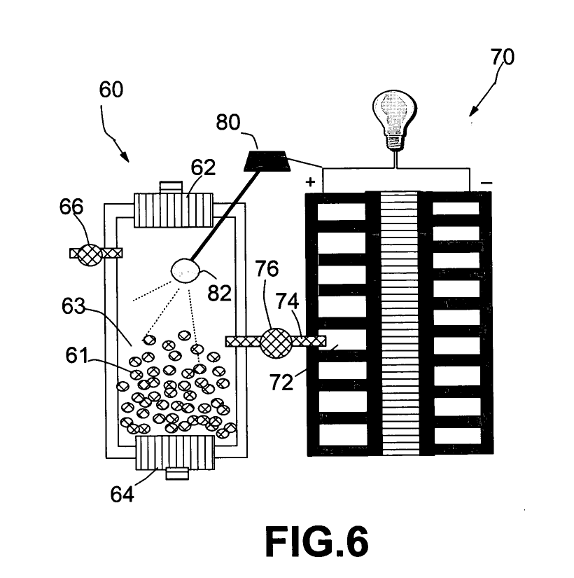

With the presently invented shell-core micro-spheres, hydrogen may now be safely and conveniently stored in a light weight container, which can feed hydrogen on demand to a fuel cell. As shown in FIG. 6, a light-weight container 60, made of a plastic or reinforced plastic (instead of heavy steel), is used to contain shell-core micro-spheres 61. The shell-core micro-spheres were hydrogen gas-filled at a high pressure, but the interior free space 63 (the space not physically occupied by micro-spheres) of the container 60 does not have to be at a high hydrogen pressure. It just has to be filled with hydrogen, displacing other types of gases such as nitrogen and oxygen outside the container. The container 60 preferably has optional openings 62,64 to allow for refilling of gas-filled micro-spheres and removal of spent micro-spheres (which are to be refilled with hydrogen perhaps at a different location). A safety valve 66 is recommended for preventing any possibility of over-pressurization in the container. A conduit 74 with a control valve 76 may be used to transport hydrogen gas, when needed, from the container 60 to a gas diffusion channel 72 on the anode side of a fuel cell 70.

In order to begin the operation of a fuel cell 70, one may choose to turn on the control valve 76 to allow for some hydrogen to flow into the gas diffusion channel 72. The power generated by the fuel cell may be partially fed back to a heating or energizing system (comprising a control 80 and a heat/energy source 82) to heat up the gas-filled micro-spheres 61 inside the container 60. This source 82 may be, as an example, a heater or an infrared lamp. The heating step is taken to raise the temperature of micro-spheres so as to decrease their fractional tensile strength ασₜ. At or above some temperature, the pressure-induced tensile stress σ of the shell will be such that ασₜ<σ, and hydrogen begins to diffuse out of the micro-spheres at a high rate to feed the fuel cell. It may be noted that the operation of a hydrogen-air fuel cell generates a significant amount of heat as an electrochemical reaction by-product. This amount of heat typically becomes wasted in a conventional fuel cell, but can be transferred back to the container 60 as a major auxiliary heat source in the present case. This will make the presently invented system a very energy-efficient one. The majority of the power generated by the fuel cell will be utilized by external electrical appliance such as a personal computer; only a small amount of power being drawn to help release the hydrogen.

Hence, one preferred embodiment of the present invention is a low power-consumption method to store and release hydrogen to a hydrogen fuel-consuming apparatus. The method includes two essential steps: (a) providing a chamber and a plurality of shell-core micro-spheres, each comprising a shell and a hollow or porous core, filled with pressurized hydrogen gas at an internal pressure P, with the chamber containing therein the micro-spheres and free spaces not occupied by the micro-spheres; and (b) heating said micro-spheres to a temperature T to reduce the tensile strength σₜ to an extent that a tensile stress a experienced by a shell of the micro-spheres meets the condition of σ≧ασₜ to cause diffusion of hydrogen outside the micro-spheres to provide hydrogen fuel from the chamber to a hydrogen-consuming device, where the material-specific parameter α has a value between 0.3 and 0.7, more typically between 0.4 and 0.6.

Light of specific wavelength ranges (e.g., infrared, IR) may be used to heat up the micro-spheres to release the hydrogen. The IR light intensity may also be adjusted to control the hydrogen flow rate. Alternatively, a heater or a hot air blower may be used to heat the micro-spheres to reach a desired temperature. It has been discovered that, for plastic micro-spheres holding a hydrogen gas pressure between 10 and 40 M Pa, a heating temperature that is within 25°, in Centigrade unit, of Tg (glass transition temperature or softening point for an amorphous, glassy polymer) or within 25° of Tm (melting point for a crystalline polymer) will be sufficient to meet the condition as set forth in Eq.(2). Therefore, a proper working temperature for heating the polymer micro-spheres to release hydrogen is withing the range of (Tg−25 degrees) and (Tg+25 degrees), but preferably in the range of (Tg−15 degrees) and Tg. A Tg no greater than 150° C. is preferred for plastic micro-spheres. For a crystalline polymer micro-sphere, a proper working temperature for heating the micro-spheres to release hydrogen is withing the range of (Tm−25 degrees) and (Tm+10 degrees), but preferably in the range of (Tm−15 degrees) and Tm.

In addition to a fuel cell, other hydrogen fuel-dependent apparatus such as a hydrogen-based combustion engine can also draw the needed hydrogen fuel from the presently invented system. Optionally, a rechargeable battery may be used to help initiate the operation of a fuel cell by providing an initial amount of the heat to help release the hydrogen. This battery can be readily recharged by the fuel cell once the fuel cell is in fill operation.

Plastic Core-Shell Particles

Methods for the production of polymer particles that are hollow or core-sheath polymer particles that contain voids (pores) are well-known in the art; e.g., Blankenship, et al. (U.S. Pat. No. 4,594,363 (Jun. 10, 1986)); Okubo (U.S. Pat. No. 4,910,229, (Mar. 20, 1990)); Touda, et al. (U.S. Pat. No. 5,077,320, (Dec. 31, 1991)); Toda, et al., U.S. Pat. No. 5,360,827 (Nov. 1, 1994)); and Walt, et al. U.S. Pat. No. 6,720,007 (Apr. 13, 2004). For instance, Blankenship, et al developed a process for making core-sheath polymer particles containing voids. The process includes (A) emulsion-polymerizing a core from a core monomer system comprised of at least one ethylenically unsaturated monomer containing acid functionality; (B) encapsulating the core with a hard sheath by emulsion polymerizing a sheath monomer system in the presence of the core with the sheath permitting penetration of fixed or permanent bases; (C) swelling at elevated temperature the resultant core-sheath polymer particles with fixed or permanent base so as to produce a dispersion of particles which, when dried, contain a microvoid. The process proposed by Touda, et al can be used to produce polymer particles containing one void or multiple voids. The process includes (a) adding a base to a latex of a carboxyl-modified copolymer containing 0.1 to 1000 parts of an organic solvent per 100 parts by weight of the carboxyl-modified copolymer to neutralize at least part of the carboxyl groups in the copolymer, and (b) adding an acid to the latex to adjust the pH of the latex to not more than 7.

The low Tg's or softening points of the plastic or rubbery shell or core wall materials make it possible to heat up the shell-core particles to release the hydrogen without consuming too much energy. We have found that the hydrogen release rate is normally low at room temperature and up to approximately 10-25 degrees Celsius below the Tg of a plastic. Within 10-25 degrees of the Tg (the temperature range varying with the plastic type), appreciable hydrogen release rates commence with the rates increasing rapidly with further temperature increases. The rate gradually reaches a plateau 10-20 degrees above the Tg. For instance, with a Tg of 150° C. as indicated in FIG. 7, polycarbonate-based structure will have a processing window of approximately 40 degrees (from 130° C. to 170° C.) in which one can adjust the hydrogen release rate to meet the potentially changing needs of an operating hydrogen fuel-consuming device like a fuel cell.

### EXAMPLE 1

### From Expandable Polystyrene Beads

The production procedures for foamed plastics are adapted herein for the preparation of porous core-solid shell plastic beads. Micrometer-sized polystyrene (PS) beads were subjected to a helium gas pressure of approximately 7 atm and a temperature near 90° C. (inside a pressure chamber) for two hours, allowing helium gas molecules to diffuse into PS beads. The chamber was then cooled down to room temperature under a high helium gas pressure condition to seal in the gas molecules. These gas-filled beads were then placed in an oven preset at 110° C., allowing the supersaturated gas molecules to try to diffuse out and, thereby, producing micro-porous PS beads or “foamed” beads that have a thin solid skin. An optical microscopy study of several cross-sections of the shell structure of foamed plastic beads reveal bi-axial orientation of polymer chains, which were formed presumably due to the bi-axial tensile stress experience by the skin portion of the plastic bead being expanded. The extent of bi-axial orientation increases with the decreasing foaming temperature. Bi-axial orientation of polymer chains is known to impart high strength to a plastic material.

### EXAMPLE 2

### Polymer Hollow Spheres

A 5-liter round bottomed flask was equipped with paddle stirrer, thermometer, nitrogen inlet and reflux condenser. To 2080 g of deionized water heated to 80° C. was added 5.5 g of sodium persulfate followed by 345 g of an acrylic polymer dispersion (40% solids) with an average particle size of 0.3 micron as the seed polymer. A monomer emulsion consisting of 55.5 g of butyl acrylate, 610.5 g of methyl methacrylate and 444 g of methacrylic acid in 406 g of water and 20 g of sodium dodecyl benzene sulfonate (23%) was added over a 2 hour period. This resulting alkali swellable core is used as the seed polymer for the following reaction:

To an identical 5-liter kettle (now empty) is added 675 g of water. After heating to 80° C., 1.7 g of sodium persulfate followed by 50.5 g (1 part by weight solids) of the above alkali swellable core is added. A monomer emulsion (9 parts by solids) consisting of 110 g of water, 0.275 g of sodium dodecylbenzene sulfonate, and a monomer mixture of 20% butyl methacrylate, 75% methyl methacrylate and 5% methacrylic acid is then added over a 2 hour period to prepare an intermediate reactive mixture. This intermediate mixture is then subjected to treatments of swelling with KOH, further polymerization, and formation of voids, as follows: To a 5-liter flask fitted with reflux condenser, nitrogen inlet and padding stirrer is added 989 g of the intermediate mixture. The reactor is heated to 85° C. and 60.9 g of 10% KOH is added for swelling purpose. The mixture is stirred at 85° C. for 30 minutes and 1.0 g of sodium persulfate is added followed by the addition of a monomer emulsion consisting of 243 g of water, 3.3 g of 23% sodium dodecyl benzene sulfonate and 576 g of styrene over a 1.5 hour period. The sample is heated at 85° C. for 15 minutes and cooled to room temperature. The hollow core sizes of the resulting particles (approximately 2.4 μm), when dried, are approximately in the range of 1.2-2.0 μm.

The produced plastic micro-spheres were then subjected to a hydrogen compression treatment so as to hold a hydrogen gas pressure between 5 and 40 MPa.

Glass Core-Shell Micro-spheres

Although some glass and ceramic hollow spheres of sufficiently small sizes (e.g., <1 μm) may exhibit relatively high strengths (e.g., up to 10,000 psi), the release of hydrogen through hollow glass or ceramic spheres at a desired rate to meet the needs of an operational fuel cell has presented a great technical challenge. This is largely due to the low gas permeability of conventional high-strength glass or ceramic materials and their high glass transition or softening temperatures. Heating of gas-pressurized hollow glass spheres to a sufficiently high temperature (close to their glass transition temperatures Tg, normally much higher than 500°) is required in order to have a sufficiently high hydrogen release rate. This would consume great amounts of energy and would take a long time to reach such high temperatures, making it impractical to use these hollow glass spheres to store and supply hydrogen to a fuel cell or combustion engine.

Inorganic glasses exhibiting low Tg enable melting and forming operations to be carried out at low temperatures with consequent savings in energy costs. These glasses are potentially useful materials for a range of applications including low temperature sealing glasses and glass-organic polymer composites.

Bartholomew, et al., in U.S. Pat. No. 4,226,628 (Oct. 7, 1980), disclosed cuprous copper and silver halophosphate glasses with Tg generally below 400° C., with some compositions showing a Tg of 170-178° C. Sanford, et al., in U.S. Pat. No. 4,314,031 (Feb. 2, 1982), disclosed tin-phosphorous oxyfluoride glasses with Tg within the range of 20° C.-290° C. Glasses having base compositions within the general zinc phosphate system have been found to exhibit low Tg. In U.S. Pat. No. 5,122,484 (Jun. 16, 1992), Beall et al. disclosed glasses exhibiting Tg below 425° C. and some below 350° C. In U.S. Pat. No. 4,996,172 (Feb. 26, 1991), Beall et al. described glasses demonstrating Tg typically between 320° C. and 350° C. In U.S. Pat. No. 5,021,366, Aitken disclosed glasses having annealing points between 300° C. and 340° C., which are fluorine-free. One inherent drawback of phosphate-based glass compositions having low Tg is their reduced resistance to attack by water and mild solutions of acids and bases, when compared to silicate-based glasses. Zinc phosphate glasses demonstrate relatively good resistance to chemical attack, when compared to other phosphate-based glasses. Additional low-Tg glasses are disclosed by Aitken and co-workers in U.S. Pat. No. 5,286,683 (Feb. 15, 1994); U.S. Pat. No. 5,529,961 (Jun. 25, 1996); and U.S. Pat. No. 6,432,851 (Aug. 13, 2002). The above inventors, however, did not propose that low-Tg glasses could be made into hollow spheres and did not recognize the potential application of low-Tg glasses for hydrogen storage.

The production of hollow glass spheres from high Tg materials is well known in the art. Beck, et al., in U.S. Pat. No. 3,365,315 (Jan. 23, 1968), disclosed a process for preparing glass bubbles by reheating solid glass particles. Torobin (U.S. Pat. No. 4,303,432, Dec. 1, 1981), developed a method for producing hollow micro-spheres by blowing a glass-forming film through an orifice and using a pulsating pressure to aid in the formation of the micro-spheres. Garnier, et al. (U.S. Pat. No. 4,661,137, Apr. 28, 1987; U.S. Pat. No. 4,778,502, Oct. 18, 1988) indicated that hollow glass spheres could be produced by grinding the glass particles, suspending these particles in a gas current, and then passing the suspended particles through a burner. In an improved method, an organic fluidizing agent may be mixed with the particles prior to being delivered into the burner. In another method, hollow borosilicate micro-spheres were produced by spray-drying a solution of sodium silicate and sodium borate in a spray tower to form a precursor, ball-milling the precursor, and heating the crushed precursor particles to a temperature higher than 600° F. (316° C.), as disclosed by Miller, et al. in U.S. Pat. No. 5,534,348 (Jul. 9, 1996). Fine hollow glass spheres are produced by preparing a precursor comprising a glass composition, a foaming agent, and some 9-20% of B₂O₃, wet-grinding the precursor to fine particles (average particle size <3 μm), and heating the fine particles to produce hollow particles of 15 μm or smaller (Tanaka, et al., U.S. Pat. No. 6,531,222, Mar. 11, 2003). No prior glass researchers have demonstrated the production of hollow glasses with a low Tg (e.g., <400° C.). We have found that low-Tg glass particles that have a hollow or porous core can be prepared by using a chemical or physical blowing method. Several examples are given as follows:

### EXAMPLES 3-A AND 3-B

Two exemplary compositions are expressed in mole percent on the oxide basis as calculated from the batch, wherein BaO and ZnO additives were included in the base P₂O₅—Ag₂O—X system, wherein X is selected from the group of Cl, Br, and I. The glasses were prepared in the following manner. Appropriate amounts of AgNO₃ and H₃PO₄ were blended together and the mixture heated to about 200° C., at which time the AgNO₃ melted and a clear, colorless, homogeneous solution resulted. Upon further heating, (e.g., up to 500° C.), water and nitrogen oxide fumes were evolved. The resulting melt was heated to about 700° C. and held at that temperature for about one hour to insure removal of water and the nitrogen oxides. A AgPO₃ glass was formed by pouring the melt onto a stainless steel block. The glass was annealed at 160° C. An appropriate amount of a silver halide was then mixed with a comminuted sample of the AgPO₃ glass and the mixture fused at about 450° C. The additives were then dissolved in the molten mass. Desired amounts of the hydrated forms of the nitrates of BaO and ZnO were added slowly to the molten P₂O₅—Ag₂O—X. A vigorous reaction ensued with oxides of nitrogen as well as water being emitted. If desired, the addition of such constituents as B₂O₃, Al₂O₃, and LiF can be made by simply incorporating them in that form into the molten P₂O₅—Ag₂O—X. The resulting P₂O₅—Ag₂O—X additive oxide glasses are generally yellow in color. The compositions are (40.7% Ag₂O+40.7% P₂O₅+14.3% AgCl+7.3% BaO) for Sample 3-A (Tg=178° C.) and (40.4% Ag₂O+40.4% P₂O₅+10% AgCl+9.2% ZnO) for Sample 3-B (Tg=170° C.), respectively. Desired amounts of the two samples were ball-milled to become glass particles of approximately 3 μm in size and then converted to spheres by annealing the particles in a steam of 230° C. These spheres were subjected to a helium gas pressure of approximately 7 atm and a temperature near 90° C. (inside a pressure chamber) for 24 hours, allowing helium gas molecules to diffuse into glass micro-spheres. The chamber was then cooled down to room temperature under a high helium gas pressure condition to seal in the gas molecules. These gas-filled beads were then placed in an oven preset at 190° C., allowing the supersaturated gas molecules to try to diffuse out and, thereby, producing micro-porous or “foamed” glass beads of approximately 15 μm in diameter. Microscopy studies indicate that these beads have a very thin solid (non-porous) skin (shell) that is typically smaller than 1 μm in size and a nano-porous core having pore sizes in the range of 50-500 nm. These beads are referred to as porous core-shell micro-spheres.

### EXAMPLE 4

A mixtures of ingredients (7% Li₂O+8%Na₂O+5% K₂O+15% CuO+30% ZnO+2% Al₂O₃+33% P₂O₅) were compounded, tumble mixed together to aid in achieving a homogeneous melt, and then charged into a crucible, which was placed in a furnace of 1000° C. for 3 hours. In the last 5 minutes, a small amount of sodium sulfate was added to the melt, which was then spray-dried to produce fine glass particles of alkali metal-Cu-Zn phosphate glass containing a chemical blowing agent, sodium sulfate. These fine glass particles were then fed into a plasma flame produced by a mixture of oxygen and propane. The decomposition of sodium sulfate produces a gas that rapidly expand the glass particles, causing the formation of a bubble. The resulting hollow glass micro-spheres have a Tg of approximately 320° C.

The presently invented shell-core micro-spheres with a hollow core or porous core are based on low-Tg glass materials. The glass shell exhibits a much higher strength (typically 3-5 times higher) as compared to engineering plastics. The gas permeability of these glasses is also much lower than that of engineering plastics, thereby significantly enhancing the hydrogen storage capability at room temperature. The low Tg's or softening points of these glass materials make it possible (and not too energy-consuming) to heat up the shell-core micro-spheres to release the hydrogen. The hydrogen release rate is found to be normally low at room temperature and up to a temperature approximately 20-50 degrees Celsius below the Tg of a glass. Within 20-50 degrees of the Tg (the temperature range varying with the glass type), appreciable hydrogen release rates commence with the rates increasing rapidly with further temperature increases. The rate gradually reaches a plateau 40 degrees above the Tg. For instance, with a Tg of 320° C. as indicated in FIG. 8, zinc-phosphate based glass shell structures will have a working temperature window of approximately 90 degrees (from approximately 270° C. to 360° C.) in which one can adjust the hydrogen release rate to meet the potentially changing needs of an operating hydrogen fuel-consuming device like a fuel cell.

Additional experimental data show that smaller glass particles have higher crushing strength as compared to larger ones. The strengths of zinc phosphate glass spheres increase from approximately 2,300 psi (diameter≈250 μm), through 3,800 psi (diameter≈90-110 μm), to 6,700 psi (diameter <5 μm). This trend is expected to be true of other glass materials based on fracture mechanics concepts which maintain that larger-sized, brittle materials tend to have a lower strength due to an increased chance to have more numerous or larger cracks.

1. A hydrogen gas storage and supply method, comprising:
(a) providing a chamber and a plurality of shell-core micro-spheres, each comprising a shell and a hollow or porous core, filled with pressurized hydrogen gas at an internal pressure P; said chamber containing therein said micro-spheres and free spaces not occupied by said micro-spheres; and
(b) heating said micro-spheres to a temperature T to reduce the tensile strength σₜ to an extent that a tensile stress a experienced by a shell of said micro-spheres meets the condition of σ≧ασₜ to cause diffusion of hydrogen outside said micro-spheres to provide hydrogen fuel from said chamber to a hydrogen-consuming device, where the material-specific parameter α has a value between 0.3 and 0.7.

2. The hydrogen gas storage and supply method as defined in claim 1, wherein said micro-spheres comprise polymer micro-spheres and the temperature T is within the range of [Tg−25° C.] to [Tg+25° C.] for an amorphous or glassy polymer (Tg=glass transition temperature or softening point) or withing the range of [Tm−25° C.] to [Tm+10° C.] for a crystalline polymer (Tm=melting point).

3. The method as defined in claim 2, wherein said heating temperature T is within the range of [Tg−15° C.] to Tg or withing the range of [Tm−15° C.] to Tm.

4. The hydrogen storage and supply method as defined in claim 1, wherein said Tg or Tm is no greater than 250° C.

5. The hydrogen storage and supply method as defined in claim 1, wherein said hydrogen-consuming device comprises a fuel cell.

6. The hydrogen storage and supply method as defined in claim 5, further including a step of utilizing a portion of the heat generated by said fuel cell to help the heating of said micro-spheres.

7. The hydrogen storage and supply method as defined in claim 5, further comprising a step of using a rechargeable battery to provide an initial amount of heat to said micro-spheres to help initiate an operation of said fuel cell.

8. The method as defined in claim 1, wherein said free spaces are filled with hydrogen gas at a pressure level lower than said internal pressure P of said micro-spheres.

9. The hydrogen storage and supply method as defined in claim 8, further comprising a step of using a portion of the hydrogen gas in said free spaces to initiate an operation of said hydrogen-consuming device.

10. The method as defined in claim 1, wherein said shell has a thickness smaller than 20% of a radius of said core-shell micro-sphere.

11. The method as defined in claim 1, wherein said shell has a thickness smaller than 10% of a radius of said core-shell micro-sphere.

12. The method as defined in claim 1, wherein said micro-spheres have a diameter smaller than 100 μm.

13. The method as defined in claim 1, wherein said micro-spheres have a diameter smaller than 5 μm.

14. The method as defined in claim 2, wherein said micro-spheres have a shell comprising bi-axially orientated polymer chains.

15. The hydrogen gas storage and supply method as defined in claim 1, wherein said micro-spheres comprise glass micro-spheres and the temperature T is within the range of [Tg−50° C.] to [Tg+50° C.] for a glass with a glass transition temperature or softening point, Tg.

16. The hydrogen storage and supply method as defined in claim 15, wherein said Tg is no greater than 400° C.

17. The hydrogen storage and supply method as defined in claim 15, wherein said Tg is no greater than 300° C.

18. The hydrogen storage and supply method as defined in claim 1, wherein said material-specific parameter α has a value between 0.4 and 0.6.
